(19) United States
(12) Patent Application Publication
(10) Pub. No.: US 2024/0341518 A1
(43) Pub. Date: Oct. 17, 2024

(54) POUR OVER CUPS AND BEVERAGE SYSTEMS COMPRISING POUR OVER CUPS

(71) Applicant: BruMate, Inc., Denver, CO (US)

(72) Inventors: Dylan M. Jacob, Denver, CO (US); Jordan Westerberg, Denver, CO (US)

(73) Assignee: BruMate, Inc., Denver, CO (US)

(21) Appl. No.: 18/135,469

(22) Filed: Apr. 17, 2023

(51) Int. Cl. A47J 31/02; A47J 31/44

(52) U.S. Cl. CPC A47J 31/02; A47J 31/446; A47J 31/20

(57) ABSTRACT

Pour over cups and systems comprising pour over cups. In an exemplary system of the present disclosure, the system comprises a beverage container and a pour over cup comprising a cylindrical wall defining an upper opening and a bottom having a surface and a plurality of apertures defined therethrough, the pour over cup further comprising a perimeter flange around the outside of the cylindrical wall and extending outward from the cylindrical wall, wherein when in use, the pour over cup is configured to be at least partially received within the beverage container, wherein the perimeter flange rests along an inner flange ledge defined within an inner portion of the beverage container.

### BACKGROUND

Pour over coffee is a process whereby a person pours hot water into a vessel with ground coffee and a filter or screen, allowing the hot water to pass through the ground coffee and into a container below. This traditional method of making coffee is experiencing a resurgence, with patrons of coffee shops frequently requesting pour over coffee.

Current pour over systems have multiple components to them, and do not nest and store together. A compact, nesting pour over system whereby all components are included and you can brew directly into the vessel you drink from would be well received for brewing coffee on the go. A system whereby a person can make pour over coffee into an insulated vessel and then enjoy the same would be well received in the marketplace.

### BRIEF SUMMARY

The present disclosure includes disclosure of a pour over cup, comprising a cylindrical wall defining an upper opening and a bottom having a surface and a plurality of apertures defined therethrough, the pour over cup further comprising a perimeter flange around the outside of the cylindrical wall and extending outward from the cylindrical wall, wherein when in use, the pour over cup is configured to be at least partially received within a beverage container.

The present disclosure includes disclosure of a pour over cup, wherein when in use, the perimeter flange is configured to rest along an inner flange ledge defined within an inner portion of the beverage container.

The present disclosure includes disclosure of a pour over cup, comprising stainless steel.

The present disclosure includes disclosure of a pour over cup, further comprising a coating selected from the group consisting of silicone and paint.

The present disclosure includes disclosure of a pour over cup, configured to receive at least part of a coffee filter therein, wherein a relative bottom of the coffee filter contacts a relative bottom of the pour over cup.

The present disclosure includes disclosure of a pour over cup, comprising part of a beverage system, the beverage system further comprising the beverage container.

The present disclosure includes disclosure of a beverage system, further comprising a lid.

The present disclosure includes disclosure of a beverage system, wherein when in use, the perimeter flange is configured to rest along an inner flange ledge defined within an inner portion of the beverage container.

The present disclosure includes disclosure of a beverage system, wherein when in use, a lower portion of the pour over cup is present within the inner portion of the beverage container, and an upper portion of the pour over cup at least partially extends above the beverage container.

The present disclosure includes disclosure of a beverage system, wherein when the pour over cup is in a stored position, the pour over cup is configured to fully fit within the inner portion of the beverage container by inverting the pour over cup.

The present disclosure includes disclosure of a beverage system, wherein when the pour over cup is in a stored position within the inner portion of the beverage container, a lid can be secured to the beverage container.

The present disclosure includes disclosure of a method of making pour over coffee, comprising the steps of positioning the pour over cup of the present disclosure at least partially within the beverage container, inserting a coffee filter at least partially within the pour over cup, placing ground coffee into the coffee filter, and pouring hot water into the coffee filter so to create liquid coffee that is ultimately received by the beverage container.

The present disclosure includes disclosure of a method of making pour over coffee, further comprising the step of adding ice to the beverage container, and optionally adding one or more of a sweetener and a milk product to the beverage container.

The present disclosure includes disclosure of a beverage system, comprising a beverage container, and a pour over cup comprising a cylindrical wall defining an upper opening and a bottom having a surface and a plurality of apertures defined therethrough, the pour over cup further comprising a perimeter flange around the outside of the cylindrical wall and extending outward from the cylindrical wall, wherein when in use, the pour over cup is configured to be at least partially received within the beverage container, wherein the perimeter flange rests along an inner flange ledge defined within an inner portion of the beverage container.

The present disclosure includes disclosure of a beverage system, further comprising a lid.

The present disclosure includes disclosure of a beverage system, wherein when in use, the perimeter flange is configured to rest along an inner flange ledge defined within an inner portion of the beverage container.

The present disclosure includes disclosure of a beverage system, wherein when in use, a lower portion of the pour over cup is present within the inner portion of the beverage container, and an upper portion of the pour over cup at least partially extends above the beverage container.

The present disclosure includes disclosure of a beverage system, wherein when the pour over cup is in a stored position, the pour over cup is configured to fully fit within the inner portion of the beverage container by inverting the pour over cup.

The present disclosure includes disclosure of a method of making pour over coffee, comprising the steps of positioning a pour over cup at least partially within a beverage container so that a perimeter flange of the pour over cup rests along an inner flange ledge defined within an inner portion of the beverage container, inserting a coffee filter at least partially within the pour over cup, placing ground coffee into the coffee filter; and pouring hot water into the coffee filter so to create liquid coffee that is ultimately received by the beverage container.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows an exploded view of elements of a pour over beverage system, according to an exemplary embodiment of the present disclosure;

FIG. 2 shows a perspective view of an exemplary pour over cup, according to an exemplary embodiment of the present disclosure;

FIG. 3 shows a bottom view of an exemplary pour over cup, according to an exemplary embodiment of the present disclosure;

FIG. 4 shows a transparent view of a pour over cup at least partially positioned within a beverage container in a configuration useful for preparing liquid coffee, according to an exemplary embodiment of the present disclosure;

FIG. 5 shows a cut-away perspective view of a pour over cup being stored within a beverage container with a lid secured thereon, according to an exemplary embodiment of the present disclosure;

FIG. 6 shows a block diagram of components of a kit, according to an exemplary embodiment of the present disclosure;

FIG. 7 shows left, front, right, back, top, bottom, and perspective views of a beverage container, according to exemplary embodiments of the present disclosure;

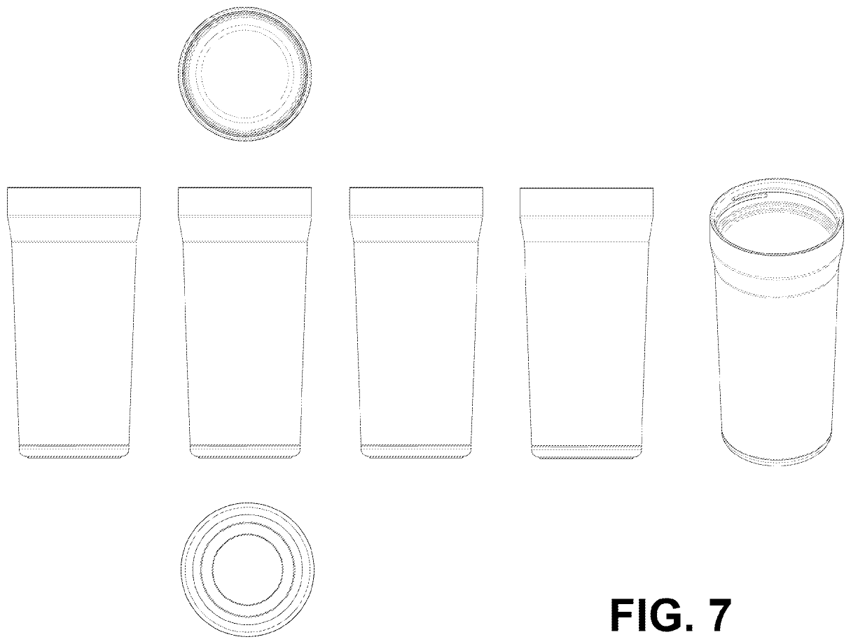

FIG. 8 shows left, front, right, back, top, bottom, and perspective views of a pour over cup, according to exemplary embodiments of the present disclosure; and

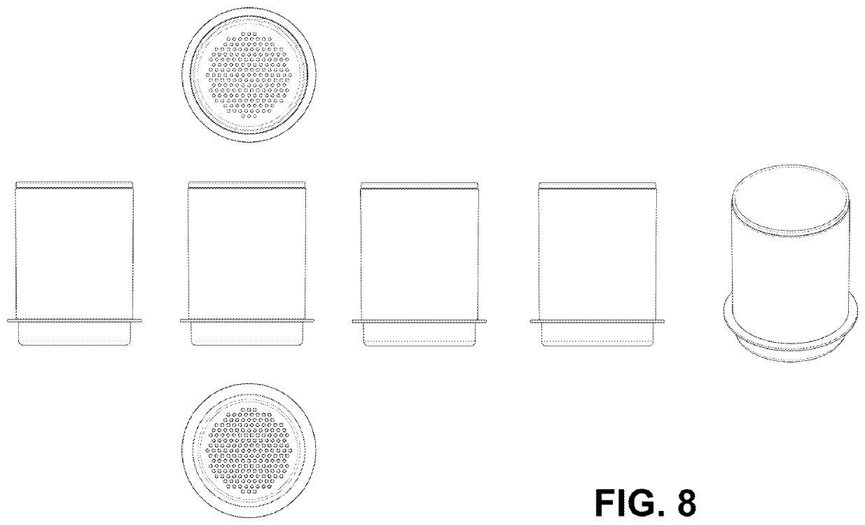

FIG. 9 shows left, front, right, top, bottom, and perspective views of a lid for a beverage container, according to exemplary embodiments of the present disclosure.

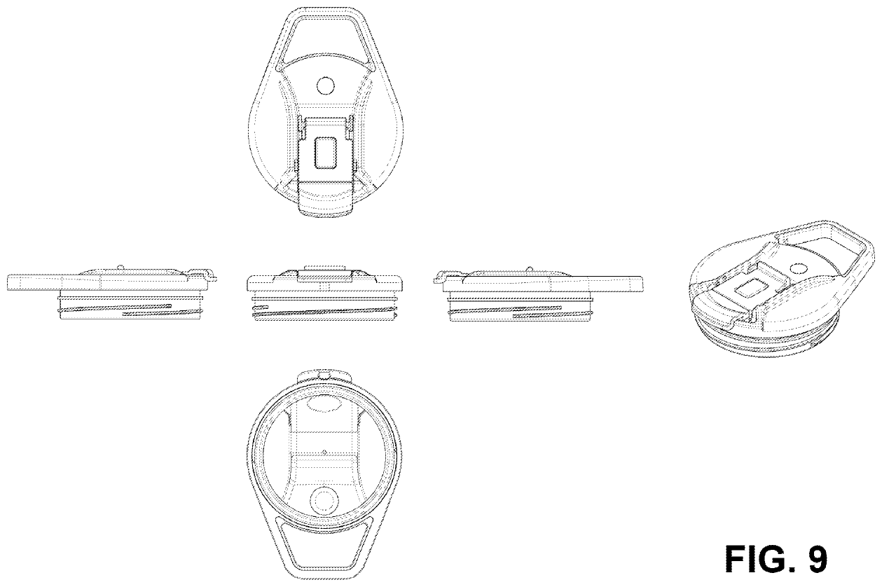

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

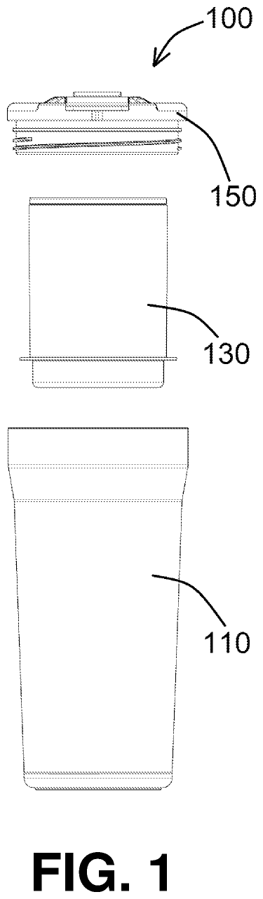

The present disclosure includes disclosure of pour over coffee systems. As shown in FIG. 1, an exemplary pour over system 100 of the present disclosure comprises an insulated beverage container 110 and a pour over cup 130. Additional system 100 embodiments of the present disclosure further comprise a lid 150 configured to engage beverage container 110.

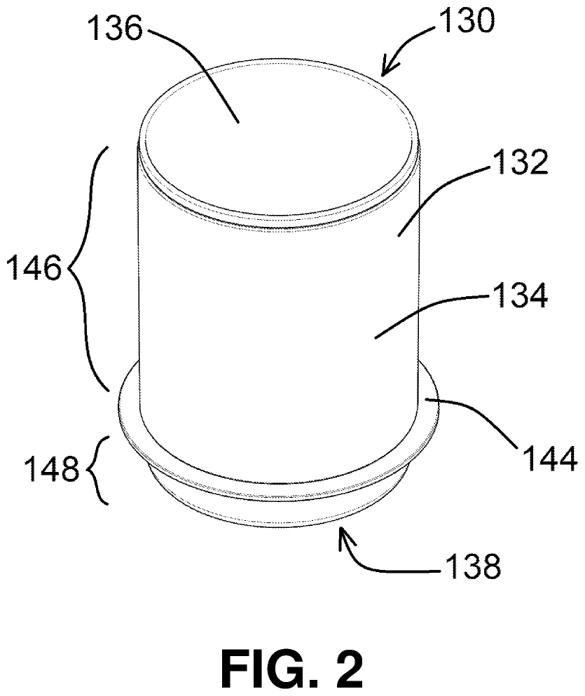

Pour over cup 130, as shown in FIG. 2, comprises a cylindrical wall 132 optionally covered in a coating 134, such as a silicone-based coating, paint, or other coating 134 known in the art. Pour over cup 130 defines an upper opening 136 (defined by cylindrical wall 132), whereby upper opening 136 is configured to receive a coffee filter 170, coffee grounds, and hot water. Cylindrical wall 132 may be comprises of stainless steel, for example.

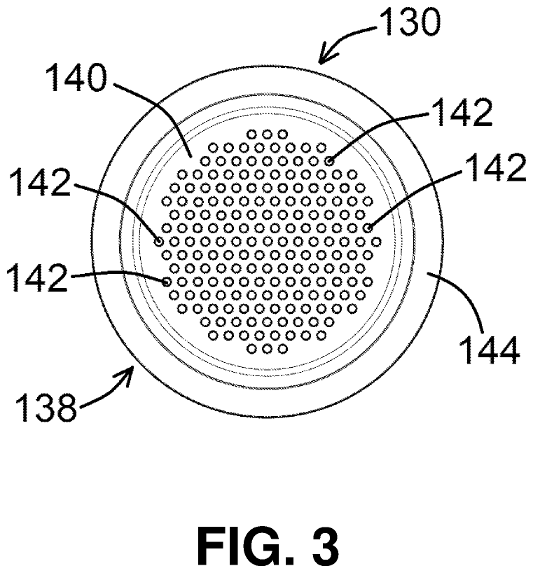

A relative bottom of pour over cup 130 is shown in FIG. 3. As shown therein, bottom 138 comprises a surface 140 having a plurality of apertures 142 defined therein. Said pour over cup 130 is therefore configured to receive coffee filter 170, coffee grounds, and hot water, whereby surface 140 is sufficient to support the weight of coffee filter 170, coffee grounds, and hot water, allowing the effective liquid coffee to pass through coffee filter 170, through apertures 142 of surface 140, and into beverage container 110 when pour over cup 130 is positioned thereupon.

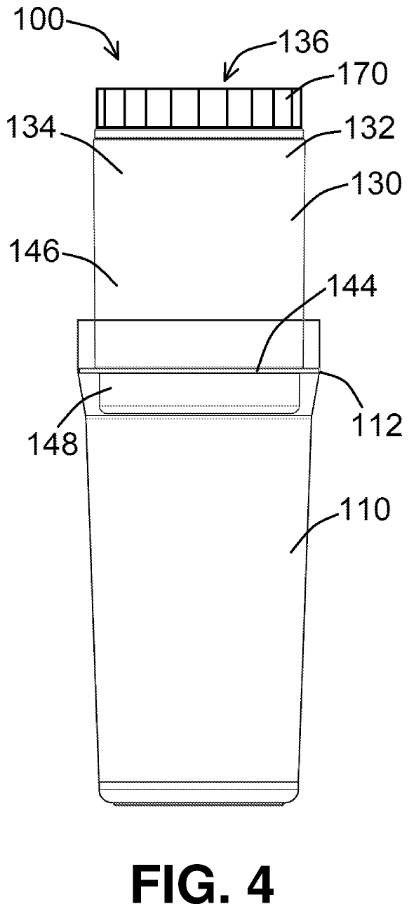

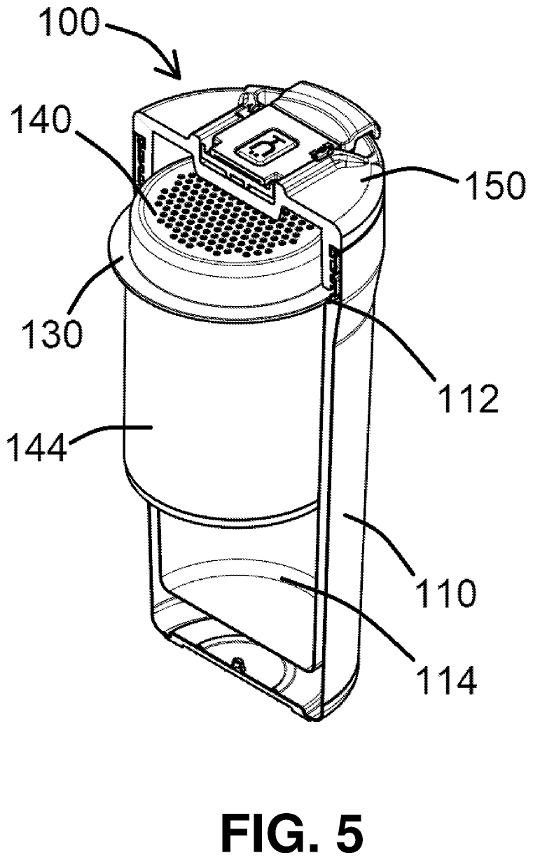

A perimeter flange 144 is defined around the outside of cylindrical wall 132 of pour over cup 130 and extending outward from cylindrical wall 132, whereby said flange 144 is configured to rest upon an inner flange ledge 112 defined within an inner portion 114 of beverage container 110, such as shown in FIG. 4. As such, and as shown in FIG. 4, pour over cup 130 can be positioned in a use position, whereby upper opening 136 is at a relative top of pour over cup 130, permitting pour over cup 130 to be used to produce liquid coffee. Pour over cup 130 can also be inverted (turned upside down), whereby flange 144 can rest upon inner flange ledge 112 defined within beverage container, so to store said pour over cup 130 within beverage container 110, as shown in FIG. 5.

Perimeter flange 144 is positioned near a lower portion of pour over cup 130, but not at the immediate bottom of pour over cup 130, such as shown in FIG. 2. Such a configuration defines an upper portion 146 and a lower portion 148 of pour over cup 130, such as shown in FIG. 2. When in use, the lower portion 148 below perimeter flange 144 is positioned within beverage container 110, while the majority of upper portion 146 remains above an upper opening 116 of beverage container 110, such as shown in FIG. 4. When stored, pour over cup 130 would be inverted, whereby the entirety of the lower portion 146 and upper portion 148 of pour over cup 130 would be positioned within an inner portion 114 of beverage container 110. A lid 150 can then be coupled to beverage container 110 so that pour over cup 130 is secured within beverage container 110 due to lid 150.

After a user has prepared pour over coffee, pour over cup 130 can be removed from beverage container 110, and the user can enjoy the liquid coffee by drinking directly from beverage container 110, with or without lid 150 secured thereupon.

Once a user has made liquid coffee, it can be enjoyed hot, warm, or cold. Should the user wish to make iced coffee, ice can be added to the beverage container 110 either before or after the liquid coffee is added to the beverage container 110. A sweetener (cane sugar, artificial sweetener, etc.) and/or a milk (cow's milk, almond milk, cashew milk, soy milk, oat milk, etc.) can also be added to the beverage container 110 before or after the liquid coffee is added to the beverage container 110.

The present disclosure includes disclosure of devices and systems configured to make tea as well. For example, instead of placing ground coffee into the coffee filter 170 and adding hot water thereto to make liquid coffee, tea leaves (chopped or ground tea leaves) can be placed into the coffee filter 170, and hot water can be added thereto to make liquid tea.

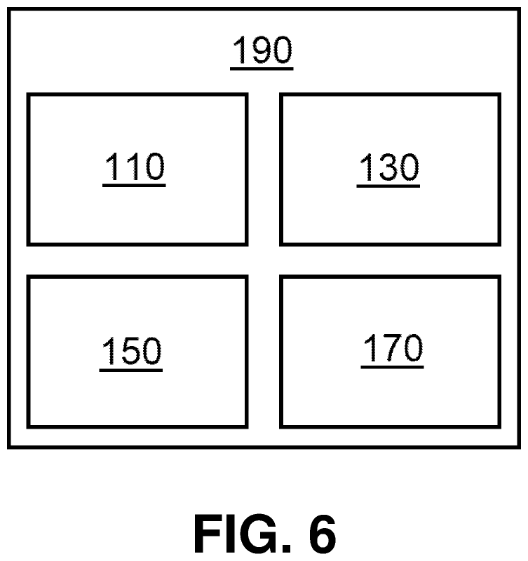

The present disclosure also includes disclosure of a kit 190, said kit comprising an exemplary beverage container 110 of the present disclosure, an exemplary pour over cup 130 of the present disclosure, and exemplary lid 150 of the present disclosure, and a quantity of coffee filters 170, such as shown in block diagram format in FIG. 6.

While various embodiments of devices, systems, and methods of using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A pour over cup, comprising:
a cylindrical wall defining an upper opening and a bottom having a surface and a plurality of apertures defined therethrough, the pour over cup further comprising a perimeter flange around the outside of the cylindrical wall and extending outward from the cylindrical wall;
wherein when in use, the pour over cup is configured to be at least partially received within a beverage container.

2. The pour over cup of claim 1, wherein when in use, the perimeter flange is configured to rest along an inner flange ledge defined within an inner portion of the beverage container.

3. The pour over cup of claim 1, comprising stainless steel.

4. The pour over cup of claim 3, further comprising a coating selected from the group consisting of silicone and paint.

5. The pour over cup of claim 1, configured to receive at least part of a coffee filter therein, wherein a relative bottom of the coffee filter contacts a relative bottom of the pour over cup.

6. The pour over cup of claim 1, comprising part of a beverage system, the beverage system further comprising the beverage container.

7. The beverage system of claim 6, further comprising a lid.

8. The beverage system of claim 6, wherein when in use, the perimeter flange is configured to rest along an inner flange ledge defined within an inner portion of the beverage container.

9. The beverage system of claim 8, wherein when in use, a lower portion of the pour over cup is present within the inner portion of the beverage container, and an upper portion of the pour over cup at least partially extends above the beverage container.

10. The beverage system of claim 8, wherein when the pour over cup is in a stored position, the pour over cup is configured to fully fit within the inner portion of the beverage container by inverting the pour over cup.

11. The beverage system of claim 10, wherein when the pour over cup is in a stored position within the inner portion of the beverage container, a lid can be secured to the beverage container.

12. A method of making pour over coffee, comprising the steps of:
positioning the pour over cup of claim 1 at least partially within the beverage container;
inserting a coffee filter at least partially within the pour over cup;
placing ground coffee into the coffee filter; and
pouring hot water into the coffee filter so to create liquid coffee that is ultimately received by the beverage container.

13. The method of claim 12, further comprising the step of:
adding ice to the beverage container; and
optionally adding one or more of a sweetener and a milk product to the beverage container.

14. A method of making pour over coffee, comprising the steps of:
positioning the pour over cup of the system of claim 6 at least partially within the beverage container;
inserting a coffee filter at least partially within the pour over cup;
placing ground coffee into the coffee filter; and
pouring hot water into the coffee filter so to create liquid coffee that is ultimately received by the beverage container.

15. A beverage system, comprising:
a beverage container; and
a pour over cup comprising a cylindrical wall defining an upper opening and a bottom having a surface and a plurality of apertures defined therethrough, the pour over cup further comprising a perimeter flange around the outside of the cylindrical wall and extending outward from the cylindrical wall;
wherein when in use, the pour over cup is configured to be at least partially received within the beverage container, wherein the perimeter flange rests along an inner flange ledge defined within an inner portion of the beverage container.

16. The beverage system of claim 15, further comprising a lid.

17. The beverage system of claim 15, wherein when in use, the perimeter flange is configured to rest along an inner flange ledge defined within an inner portion of the beverage container.

18. The beverage system of claim 17, wherein when in use, a lower portion of the pour over cup is present within the inner portion of the beverage container, and an upper portion of the pour over cup at least partially extends above the beverage container.

19. The beverage system of claim 17, wherein when the pour over cup is in a stored position, the pour over cup is configured to fully fit within the inner portion of the beverage container by inverting the pour over cup.

20. A method of making pour over coffee, comprising the steps of:
positioning a pour over cup at least partially within a beverage container so that a perimeter flange of the pour over cup rests along an inner flange ledge defined within an inner portion of the beverage container;
inserting a coffee filter at least partially within the pour over cup;
placing ground coffee into the coffee filter; and
pouring hot water into the coffee filter so to create liquid coffee that is ultimately received by the beverage container.
